(19) United States
(12) Patent Application Publication
(10) Pub. No.: US 2004/0116096 A1
(43) Pub. Date: Jun. 17, 2004

(54) Radio frequency receiver architecture with tracking image-reject polyphase filtering

(75) Inventor: David H. Shen, Saratoga, CA (US)

Correspondence Address: DAVID H. SHEN, IRF Semiconductor, Inc., 6 RESULTS WAY, CUPERTINO, CA, 95014, US

(73) Assignee: IRF SEMICONDUCTOR, INC.

(21) Appl. No.: 10/729,343

(22) Filed: Dec. 5, 2003

Related U.S. Application Data
(60) Provisional application No. 60/431,980, filed on Dec. 10, 2002.

(51) Int. Cl. H04B 1/26

(52) U.S. Cl. 455/323; 455/326

(57) ABSTRACT

A RF communications receiver is disclosed which permits greater integration on standard silicon chips and consumes less power than previous receivers. A new method for using a tracking polyphase filter for image rejection of variable intermediate frequencies is introduced. This method allows for reduce sensitivity to resistor and capacitor manufacturing variations and allows for the polyphase filter response to be enhanced compared to the prior art.

This application is based on the provisional application No. 60/431,980 filed on Dec. 10, 2002

### REFERENCE

[1] F. Behbahani et al, “CMOS Mixers and Polyphase Filters for Large Image Rejection,” IEEE Journal of Solid-State Circuits, vol. 36, no. 6, June 2001, pp. 873-887.

### BACKGROUND

1. Technical Field of Invention

RF Receiver Architecture with Tracking IR Polyphase Filtering-David H. Shen, Nov. 20, 2003 Page 1 The present invention relates to radio receivers and methods for the reception of RF (radio frequency) communications signals in multiple frequency bands. In particular, it relates to integrated circuit based radio receivers using on-chip tuning methods to improve performance and manufacturability.

2. Background of the Invention and Discussion of Prior Art

At the present time, the vast majority of RF communications receivers are of the superheterodyne type. This type of receiver uses one or more IF (intermediate frequency) stages for filtering and amplifying signals at a fixed frequency within an IF chain. This radio architecture has the advantage that fixed filters may be used in the LO chain. In order for the receiver to be useable over multiple bands, its typical architecture is as the dual-band receiver shown in FIG. 1. An RF signal arriving at an antenna 11 passes through a band-select RF filter 13, an LNA (low noise amplifier), 15, and into an image filter, 17, which produce a band-limited RF signal. This band-limited RF signal then enters a first mixer 19, which translates the RF signal down to an intermediate frequency by mixing it with the signal produced by the first LO (local oscillator) 21. The undesired mixer products in the IF signal are rejected by an IF filter, 23. The filtered IF signal then enters an IF amplifier stage, 25, after which the outputs feeds into the second mixer 27 which translates it down to yet another intermediate frequency by mixing it with the signal produced by a second LO, 28. The signal is then sent to the baseband processing. Tuning into a particular channel within the band-limited RF signal is accomplished by varying the frequency of each LO, 21 and 28.

In order to reduce size, power consumption, and cost, it would be advantageous to integrate the electronic components of radio receivers and reduce the number of filters and mixers. The superheterodyne design, however, requires high quality, narrowband IF bandpass filters that are typically implemented off-chip. These filtering components impose a lower limit to the size, materials cost, assembly cost, and power consumption of receivers built using the superheterodyne design. Moreover, the necessity for mixer and local oscillator circuits operating at high frequencies contributes greatly to the power consumption and general complexity of the superheterodyne receiver. In particular, the high-frequency analog mixers require a large amount of power to maintain linear operation. Although many variations of the superheterodyne design exist, they all share the limitations of the particular design just described.

The growing demand for portable communications has motivated attempts to design radio receivers that permit the integration of more components onto a single chip. Recent advances in semiconductor processing of inductors are allowing more and more of these filters to be implemented on-chip.

A second receiver design is the direct-conversion, or zero-IF, receiver shown in FIG. 2. An antenna 57 couples a RF signal through a first bandpass RF filter, 59, into a LNA, 61. The signal then proceeds through a second RF filter 63, yielding a band-limited RF signal, which then enters a mixer, 65, and mixes with an LO frequency produced by an LO, 67. Up to this point, the direct-conversion receiver design is essentially the same as the previous receiver design.

Unlike the previous designs, however, the LO frequency is set to the carrier frequency of the RF channel of interest. The resulting mixer product is a zero-frequency IF signal—a modulated signal at baseband frequency. The mixer output, 67, is coupled into a lowpass analog filter 69 before proceeding into baseband information signal for use by the remainder of the communications system. In either case, tuning is accomplished by varying the frequency of LO, 67, thereby converting different RF channels to zero-frequency IF signals.

Because the direct-conversion receiver design produces a zero-frequency IF signal, its filter requirements are greatly simplified—no external IF filter components are needed since the zero-IF signal is an audio frequency signal that can be filtered by a low-quality lowpass filter. This allows the receiver to be integrated in a standard silicon process from mixer 65 onwards, making the direct-conversion receiver design potentially attractive for portable applications.

The direct-conversion design, however, has several problems, some of which are quite serious. As with the other designs described above, the RF and image filters required in the direct-conversion design must be high-quality narrowband filters that must remain off-chip. Moreover, this design requires the use of high-frequency mixer and LO circuits that require large amounts of power. Additionally, radiated power from LO, 67, can couple into antenna 57, producing a DC offset at the output of mixer, 65. This DC offset can be much greater than the desired zero-IF signal, making signal reception difficult. Radiated power from LO 67 can also affect other nearby direct-conversion receivers tuned to the same radio frequency.

In summary, although the prior art includes various receiver designs, each one has significant disadvantages including one or more of the following: the necessity for several external circuit components, the consumption of large amounts of power, poor signal reception, poor selectivity, distortion, and limited dynamic range.

### OBJECTS AND ADVANTAGES OF THE INVENTION

Accordingly, it is a primary object of the present invention to provide a multiple frequency band radio receiver design, which has increased integration and decreased power consumption without the operational problems associated with previous receiver designs. It is a further object of the invention to provide an equivalent performance to the traditional multi-band superheterodyne receiver of FIG. 1. A novel method for polyphase filtering is introduced. This method allows the polyphase fitler to have reduce sensitivity to resistor and capacitor manufacturing variations and allows for the polyphase filter response to be enhanced compared to the prior art.

### SUMMARY OF THE INVENTION

The present invention achieves the above objects and advantages by providing a new method for RF communications signal reception and a new receiver design that incorporates this method. This method includes a method for using a variable intermediate frequency, and on-chip image-rejection filtering that tunes out process variations and tracks the variable intermediate frequency. The highly integrated solution allows for significant cost savings, board area savings, and power savings compared to prior art solutions.

### DESCRIPTION OF DRAWINGS

FIG. 1 is a block diagram of a superheterodyne receiver considered as prior art.

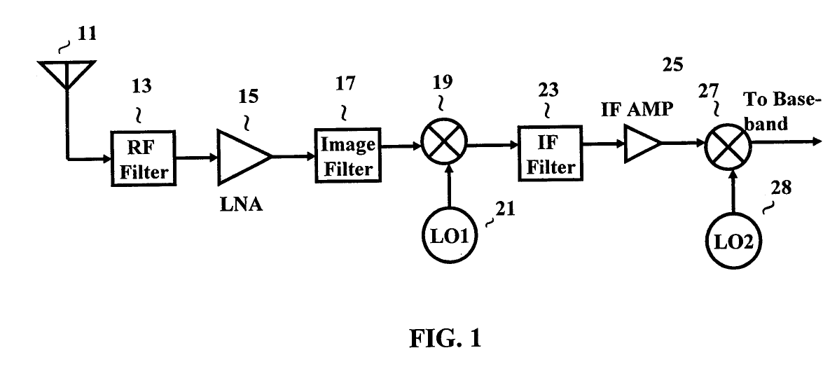

FIG. 2 is a block diagram of a direct-conversion receiver considered as prior art.

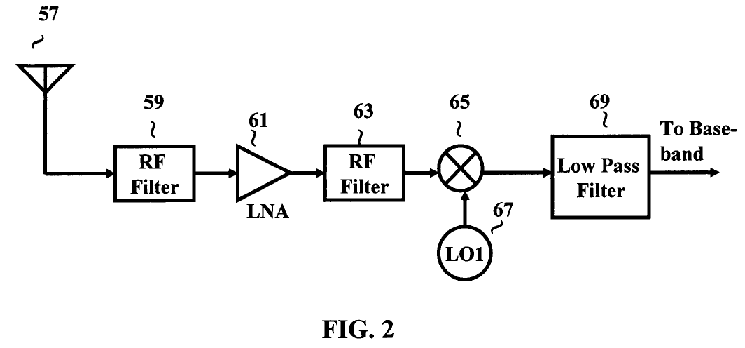

FIG. 3 is a block diagram of a receiver constructed with the principles of the invention.

FIG. 4 is an example of an implementation the tracking polyphase filter with tunable capacitors.

FIG. 5 is an example of the implementation of a tunable capacitor.

FIG. 6 is an example of an implementation the tracking polyphase filter with tunable resistors.

FIG. 7 is an example of a tunable resistor.

FIG. 8 is an example of the R-C tuning circuit.

### DESCRIPTION OF THE PREFERRED EMBODIMENT

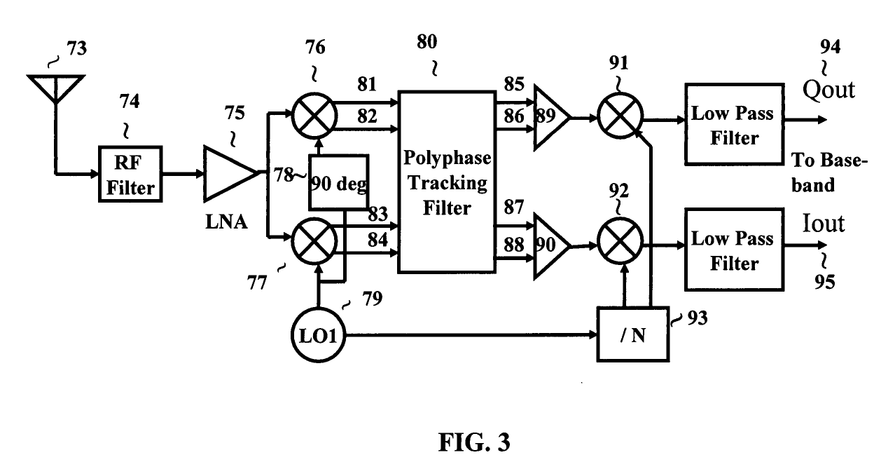

FIG. 3 is a block diagram of a RF communications receiver constructed in accordance with the principles of the present invention. It includes an antenna 73 for coupling a RF signal into the input of a bandpass RF filter, 74. The output of the analog bandpass RF filter, 74, connects to the input of an LNA, 75, whose output couples to the input of two mixers, 76 and 77. The in-phase (I) mixer, 77, is driven by the local oscillator, 79, output. The quadrature-phase (Q) mixer, 76, is driven by the output of a 90 degree phase shifter, 78, whose input is connected to the local oscillator, 79, output. The mixer outputs are differential in-phase signals 83 and 84 and differential quadrature signals 81 and 82 that are frequency translated to a variable intermediate frequency. The mixer outputs, 81, 82, 83 and 84, are inputs into a tracking polyphase filter, 80. The tracking polyphase filter, 80, response is tunable to the variable intermediate frequency and is also calibrated against resistor and capacitor variations through a tuning circuit, 116.

The outputs, 85-88, of the tracking polyphase filter, 80, are amplified by intermediate frequency amplifiers, 89 and 90. The outputs of the intermediate frequency amplifiers are connected to the inputs of the second mixers, 89 and 90, that mixes with a divided version of the local oscillator, 79, to frequency translate the desired signal to baseband. The frequency divider, 93, divides the frequency of the first local oscillator, 79, to form a second local oscillator frequency that tracks the first local oscillator. This causes the first intermediate frequency to be variable. In order for the polyphase filter, 80, to effective suppress the image frequencies of a variable intermediate frequency, its center frequency should vary with the local oscillator, 79. The tracking intermediate frequency filter ensures that the image rejection is strongest for the unwanted image signal regardless of the value of the variable intermediate frequency. This method guarantees high performance throughout the frequencies of the received band. The generation of the second local oscillator frequency through frequency divider, 93, is more power efficient and lower noise than utilizing a second local oscillator.

A polyphase filter is an integrated filter known in the art that can produce selective image rejection of either positive or negative frequencies by combining the I and Q signals with an R-C filter network [1]. The polyphase filter can pass a desired frequency while rejecting an image frequency. A conventional polyphase filter image rejection response is limited by resistor and capacitor component variations. In addition, the use of a variable intermediate frequency causes the filter response to be mismatched with the image frequency. These factors prevent a high quality image rejection response from the polyphase filters. Polyphase filters can be cascaded to improve image-response at the cost of reducing the gain of the desired signal.

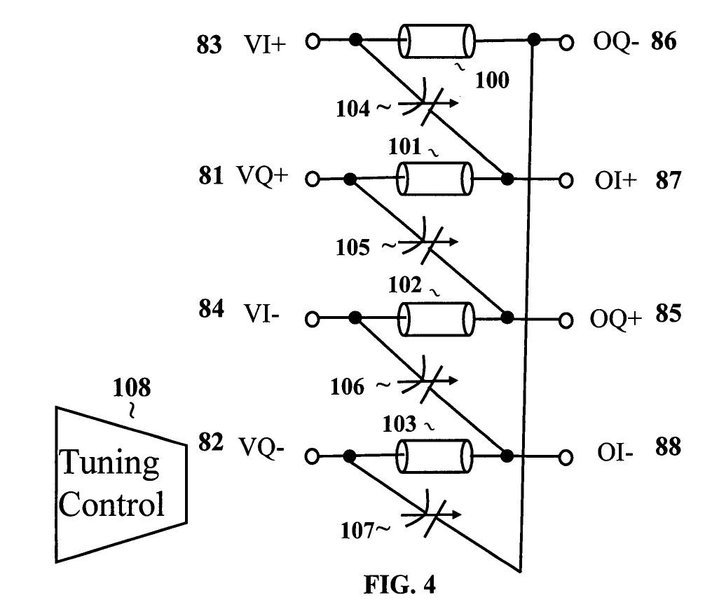

FIG. 4 gives a possible implementation of the tracking polyphase filter, 80, in a form that can be implemented with on-chip resistors, 100-103, and capacitors, 104-107, which can be adjusted by tuning a switched-capacitor array. There are many ways of generating a variable capacitor array, including binary-weighted parallel capacitors or linearly-weighted parallel capacitors. The control voltages for the capacitor array can be generated by the tuning circuit, 108. The voltage inputs, 81-84, of the tracking polyphase filter, 80, are filtered to produce voltage outputs, 86-88. The tracking polyphase filter, 80, can be implemented as a single-ended or differential circuit.

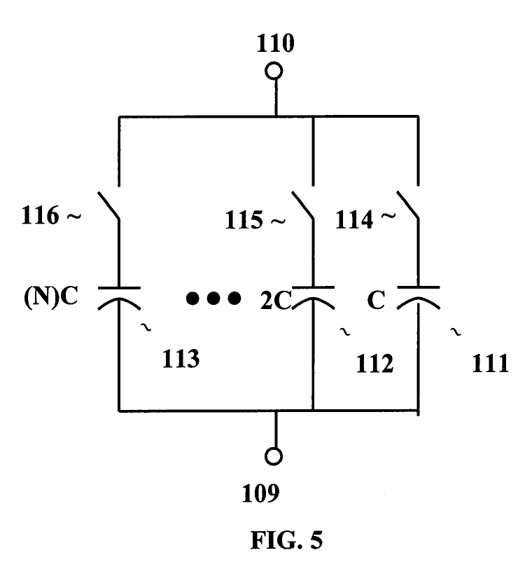

FIG. 5 is a possible implementation of the switched capacitor array. Terminals 109 and 110 are connected to a binary-weighted switched capacitor array. Capacitors 111-113 are connected to switches 114-117, which can be programmed by digital control.

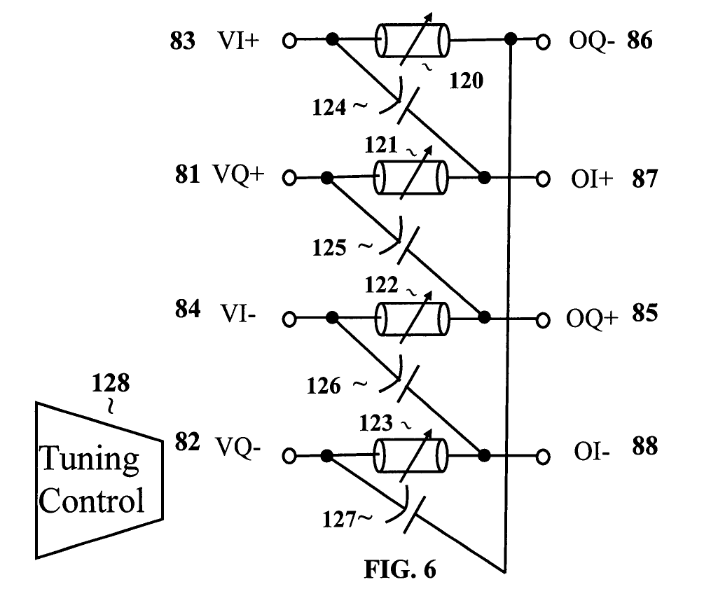

FIG. 6 gives another possible implementation of the tracking polyphase filter, 80, in a form that can be implemented with on-chip tunable resistors, 120-123, and fixed capacitors, 124-127. There are many ways of generating a variable resistor array, including binary-weighted parallel resistors or linearly-weighted parallel resistors. In addition, binary or linearly weighted series resistors can also be used. An analog control voltage can be used to adjust a MOS device in the triode region for continuous control. The control signals for the resistor array can be generated by the tuning circuit, 128. There are many known ways in the art to generate a circuit to tune the R-C values, such as a phase-locked loop. The voltage inputs, 81-84, of the tracking polyphase filter, 80, are filtered to produce voltage outputs, 86-88.

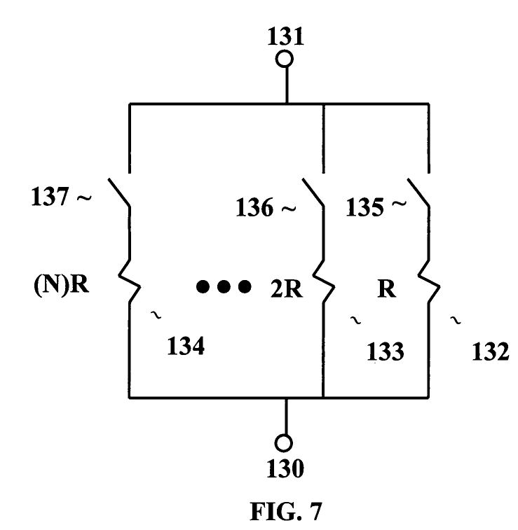

FIG. 7 is a possible implementation of a parallel switched resistor array. Terminals 130 and 131 are connected to a binary-weighted switched resistor array. Resistors 132-134 are connected to switches 135-138, which can be programmed by digital control.

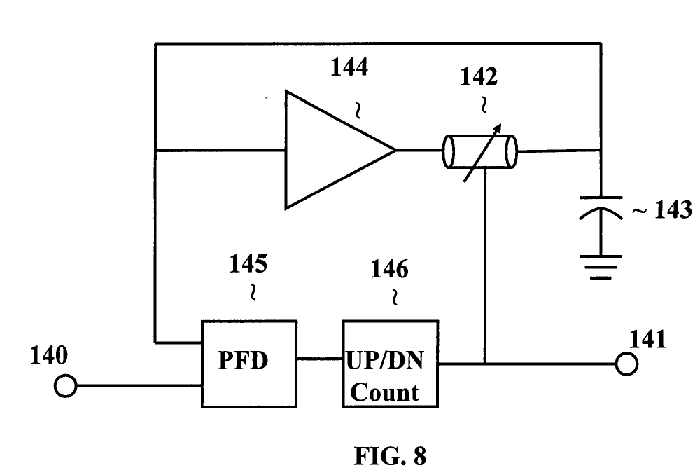

FIG. 8 gives a possible implementation of a phase-locked loop based tuning circuit. Reference frequency, 140, is a fixed frequency input to the circuit. Amplifier, 144, in combination with a delay element formed by R-C network, 142 and 143, form the basis of an oscillator that is tuned by digital control signal 141. The digital control signal, 141, is generated by an up/down counter, 146, with up and down signals generated by the phase-frequency detector, 145. The tuning circuit, when locked, forces the R-C time constant to track the frequency of the reference, thus tuning out the manufacturing process variations of the resistors and capacitors. By changing the reference frequency, 140, to track the variable intermediate frequency, the polyphase filter, 80, can be made to track the intermediate frequency.

The tracking polyphase filter, 80, can be one stage or multiple stages of polyphase filters. The polyphase filter can be an active or passive network. The polyphase filter can be tuned by varying the resistors or the capacitors, and there are many possible implementations of the tuning circuit. These and other modifications, which are obvious to those skilled in the art, are intended to be included within the scope of the present invention. Accordingly, the scope of the invention should be determined not by the embodiment described, but by the appended claims and their legal equivalents.

1. A method for a highly integrated radio receiver design comprising of
an in-phase mixer with one input connected to an RF input signal, and another input connected to a local oscillator signal,
a quadrature mixer with one input connected to said RF input signal, and another input connected to a 90 degree phase shifted local oscillator signal,
a polyphase image-reject filter with the ability to be tuned to track the intermediate frequency, the input of said polyphase image-reject filter connected to the outputs of said mixers,
a tuning circuit with a reference frequency input and whose output is used to control the tuning of said polyphase image-reject filter.

2. The method of claim 1 wherein the polyphase filter is followed by a second mixer with one input connected to a divided down local oscillator signal.

3. The method of claim 1 wherein the polyphase filter is followed by an intermediate frequency amplifier.

4. The method of claim 1 wherein the polyphase filter stage is followed by another polyphase filter stage.

5. The method of claim 1 wherein the polyphase filter is preceded by a buffer.

6. The method of claim 1 wherein the polyphase filter is preceded by an intermediate frequency amplifier.

7. The method of claim 1 wherein the polyphase filter consists of a resistor and capacitor network where the resistors are tunable.

8. The method of claim 1 wherein the polyphase filter consists of a resistor and capacitor network where the capacitors are tunable.

9. The method of claim 1 wherein the polyphase filter comprises both active and passive elements.

10. The method of claim 1 wherein the polyphase filter comprises of an amplifier, resistors, and capacitors.

11. The method of claim 1 wherein the receiver is implemented in CMOS technology.

12. The method of claim 1 wherein the receiver is implemented in any integrated circuit technology.
